(19) United States
(12) Patent Application Publication
(10) Pub. No.: US 2023/0097394 A1
(43) Pub. Date: Mar. 30, 2023

(54) VEHICLE BODY REAR STRUCTURE

(71) Applicant: Honda Motor Co., Ltd., Tokyo (JP)

(72) Inventors: Kazuma NAGAO, Tokyo (JP); Kazuhiko KAMEDA, Tokyo (JP); Kei OSHIDA, Saitama (JP)

(73) Assignee: Honda Motor Co., Ltd., Tokyo (JP)

(21) Appl. No.: 17/903,028

(22) Filed: Sep. 5, 2022

(30) Foreign Application Priority Data
Sep. 30, 2021 (CN) 202111163716.X

(51) Int. Cl. B60R 11/04; B60S 1/46

(52) U.S. Cl. CPC B60R 11/04; B60S 1/46

(57) ABSTRACT

A vehicle body rear structure in which a protruding structure is disposed further rearward of a camera device, so that water droplets dropping on the surface of the vehicle body roll and pass through the protruding structure and thus are prevented from adhering to the camera device. The vehicle body rear structure includes: a camera device disposed at the rear of a vehicle; an exterior member having a mounting surface on which the camera device is mounted and a tilted surface tilted from the mounting surface toward a rear upper part of the vehicle; and a protruding strip portion disposed at a position further rearward of the vehicle than the camera device and further forward of the vehicle than the tilted surface.

### CROSS-REFERENCE TO RELATED APPLICATION

This application claims the priority benefit of Chinese application no. 202111163716.X, filed on Sep. 30, 2021. The entirety of the above-mentioned patent application is hereby incorporated by reference herein and made a part of this specification.

### BACKGROUND

### Technical Field

The disclosure relates to a vehicle body rear structure, and in particular, relates to a vehicle body rear structure of a vehicle.

### Description of Related Art

In recent years, efforts to build safe cities and human settlements have been stepped up in all countries, with an aim to strengthen capacities for inclusive and sustainable urban development as well as planning management of sustainable human settlements in all countries. Therefore, in all countries, safe, affordable, accessible, and sustainable transportation systems are required to be available to all people, and road safety also needs to be improved, especially for the expansion of public transportation, special attention needs to be put to the needed of people in vulnerable conditions such as women, children, people with disabilities and the elderly. In the transportation sector, there is an urgent need to take steps to address environmental concerns in order to develop technologies that can be used to improve the convenience and safety of public transportation.

Regarding the vehicle manufacturing industry, a camera device mounted on the rear of a vehicle for detecting the presence or absence of an object behind the vehicle and the distance or relative position between the object and the vehicle is disclosed by the related art. A vehicle body rear structure including a recessed portion in a tailgate for allowing a license plate to be mounted on, a camera device provided on the upper side of the recessed portion, and a garnish piece covering the camera device from above is also disclosed by the related art.

However, if a vehicle is driven in the rain, raindrops may adhere to the rear of the vehicle body. If the water droplets drop from the lower edge of the garnish piece, form water droplets within the viewing angle range of the camera device, and then are reflected in the image captured by the camera device, the visibility based on the camera device may be affected. Since the image captured by the camera device is affected by the water droplets due to the adhesion of water droplets, the image captured by the camera device may not be clear.

A vehicle body rear structure that suppresses the formation of water droplets within the viewing angle range of the camera device is disclosed by the related art. In the related art, a shielding structure covering the camera device on the outer side panel of the rear door is provided to prevent rainwater from splashing on the camera device. However, in the related art, when there is a structure in which the surface of the license garnish is tilted toward the direction of the camera device, it is not possible to completely prevent rainwater or water droplets from adhering to the camera device. Therefore, there is a need to prevent water droplets at the rear of the vehicle body from adhering to the camera device as much as possible.

### SUMMARY

In view of the above, the purpose of the disclosure aims to provide a vehicle body rear structure in which a protruding structure is disposed further rearward of the camera device, so that water droplets dropping on the surface of the vehicle body roll and pass through the protruding structure and thus are prevented from adhering to the camera device.

[1] To achieve the foregoing purpose, the disclosure provides a vehicle body rear structure including a camera device, an exterior member, and a protruding strip portion. The camera device is disposed at the rear of a vehicle. The exterior member has a mounting surface on which the camera device is mounted and a tilted surface tilted from the mounting surface toward a rear upper part of the vehicle. The protruding strip portion is disposed at a position further rearward of the vehicle than the camera device and further forward of the vehicle than the tilted surface.

According to the disclosure, the protruding strip portion is disposed at a position further rearward of the vehicle than the camera device and further forward of the vehicle than the tilted surface. The water droplets at the rear of the vehicle roll downward along the tilted surface, and the water droplets rolling along the tilted surface can pass through the protruding strip portion and then are certain to fall down without adhering to the camera device.

[2] Further, in this disclosure, the exterior member includes an appearance surface from which an appearance design may be observed from the rear of the vehicle, and the tilted surface is tilted further forward of the vehicle than the appearance surface.

According to such a structure, the appearance surface of the exterior member is connected to the tilted surface, and the tilted surface is arranged to be tilted further forward of the vehicle from the appearance surface. Therefore, when viewed from the rear of the vehicle, the degrees of tilting of the appearance surface and the tilted surface change, so designability of the exterior member is enhanced, and the aesthetic feeling and the sense of design are thereby improved.

[3] Further, in the disclosure, the vehicle body rear structure further includes a side protruding portion continuously arranged with the protruding strip portion and located on a side of the camera device. The side protruding portion covers at least a portion of the camera device.

According to such a structure, through arrangement of the side protruding portion, the water droplets passing through the side protruding portion along the side of the camera device are certain to fall down.

[4] Further, in this disclosure, the camera device includes a lens, and the side protruding portion is arranged to face further forward of the vehicle than the lens to be continuous with the protruding strip portion.

According to such a structure, the water droplets directed toward the lens from the side of the camera device are certain to fall down via the side protruding portion.

[5] Further, in this disclosure, the vehicle body rear structure further includes a nozzle disposed at a position further rearward of the vehicle than the camera device and configured for ejecting liquid toward the camera device. The nozzle and the camera device are arranged not to overlap in a vehicle width direction. The nozzle and the protruding strip portion are arranged side by side in the vehicle width direction, and the protruding strip portion is arranged to be closer to the camera device side than the nozzle.

According to such a structure, by arranging the protruding strip portion to be closer to the camera device side than the nozzle, water droplets are surely prevented from adhering to the camera device. Further, by arranging the nozzle and the camera device not to overlap in the vehicle width direction, water droplets are surely prevented from adhering to the camera device.

[6] Further, in this disclosure, the vehicle body rear structure further includes an extension portion located between the protruding strip portion and the nozzle and extending from an end of the protruding strip portion adjacent to the nozzle toward the camera device.

According to such a structure, by providing the extension portion between the protruding strip portion and the nozzle, water droplets may be prevented from detouring from the side surface of the protruding strip portion and adhering to the camera device.

[7] Further, in the disclosure, the extension portion is arranged not to overlap an ejection range of the liquid from the nozzle.

According to such a structure, the detouring of water droplets may be prevented from occurring by the extension portion. Further, by arranging the extension portion not to overlap the ejection range of the liquid from the nozzle, cleaning of the lens of the camera device is not hindered.

[8] Further, in the disclosure, the vehicle body rear structure further includes a side protruding portion continuously arranged with the protruding strip portion and located on a side of the camera device opposite to the nozzle. The side protruding portion covers at least a portion of the camera device.

According to such a structure, the water droplets passing through the side protruding portion along the side of the camera device are certain to fall down.

[9] Further, in the disclosure, the vehicle body rear structure further includes a bracket. The camera device is mounted on the exterior member via the bracket, and the nozzle is disposed on the bracket.

According to such a structure, through arrangement of the bracket, the nozzle may be easily and conveniently mounted on the bracket.

[10] Further, in the disclosure, the vehicle body rear structure further includes a bracket. The camera device is mounted on the exterior member via the bracket, and the protruding strip portion is disposed on the bracket.

According to such a structure, through arrangement of the bracket, the protruding strip portion may be easily and conveniently mounted on the bracket.

[11] Further, in the disclosure, the protruding strip portion is at least formed at a vehicle rear side end portion of the bracket. A groove-shaped gap is formed between the vehicle rear side end portion of the bracket and the exterior member.

According to such a structure, water droplets may enter the gap formed between the bracket and the exterior member. After the water droplets are accumulated, larger water droplets are formed, and the water droplets pass through the protruding strip portion and then are certain to fall down.

To sum up, in the vehicle body rear structure provided by the disclosure, the protruding strip portion is disposed at a position further rearward of the vehicle than the camera device and further forward of the vehicle than the tilted surface of the exterior member. In this way, the water droplets at the rear of the vehicle roll downward along the tilted surface and reach the protruding strip portion when rolling to the lower end edge of the tilted surface. Therefore, the water droplets do not roll to the place where the camera device is located. After reaching the protruding strip portion, the water droplets dropping along the tilted surface can pass through the protruding strip portion and are certain to fall down, such that the water droplets are surely prevented from adhering to the camera device.

To make the aforementioned and other features and advantages of the disclosure more comprehensible, several embodiments accompanied with drawings are described in detail as follows.

### BRIEF DESCRIPTION OF THE DRAWINGS

FIG. 1 is a schematic view of a vehicle having a vehicle body rear structure according to an embodiment of the disclosure.

FIG. 2 is a schematic view of the vehicle body rear structure according to an embodiment of the disclosure.

FIG. 3 is a schematic cross-sectional view taken along a line AA in FIG. 2.

FIG. 4 is a schematic view of the vehicle body rear structure of FIG. 2 viewed from a different viewing angle.

FIG. 5 is a schematic view of a vehicle body rear structure according to another embodiment of the disclosure.

### DESCRIPTION OF THE EMBODIMENTS

Hereinafter, embodiments of the disclosure are to be described based on the drawings. Note that in each of the embodiments to be described below, the same reference numerals are assigned to the common parts, so that repeated description may not to be provided. Hereinafter, embodiments of the disclosure are be described with reference to the drawings. In the embodiments to be described below, when referring to the number, amount, etc., unless otherwise specified, the scope of the disclosure is not necessarily limited to the number, amount, and the like. In addition, in the embodiments to be described below, each constituent element is not necessarily essential to the disclosure unless specifically described. Besides, when a plurality of embodiments are to be described below, unless otherwise specified, the feature parts that can be appropriately combined in each embodiment are predetermined from the beginning.

With reference to the drawings, description of a vehicle body rear structure provided by the embodiments of the disclosure is provided. In the drawings, X represents the front direction in the front-rear direction of the vehicle, Z represents the upper direction in the vertical direction of the vehicle, and Y represents the inner direction in the width direction of the vehicle. Besides, the directions and positions described in the specification of the disclosure are defined on the premise that the front of the vehicle is facing forward.

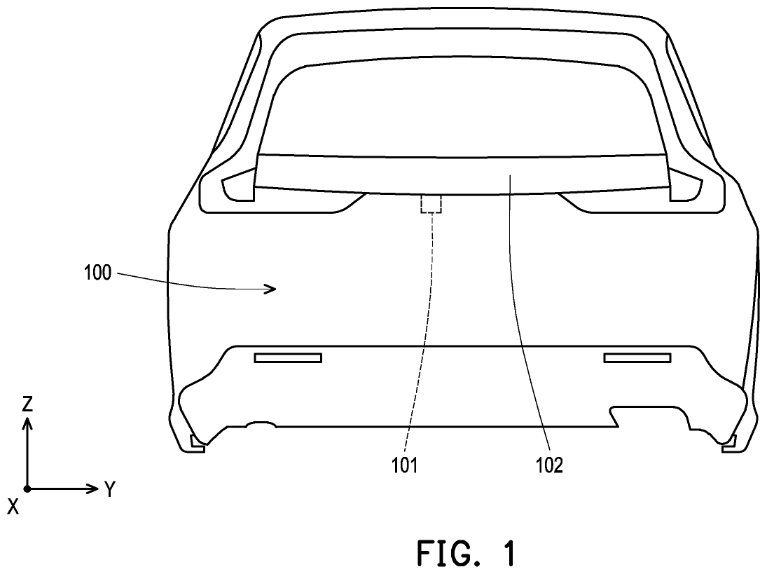

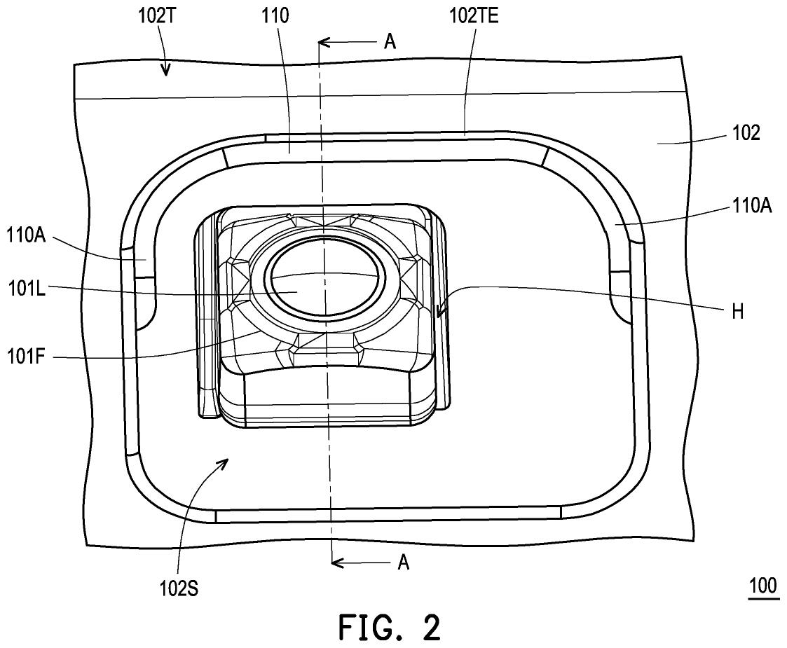

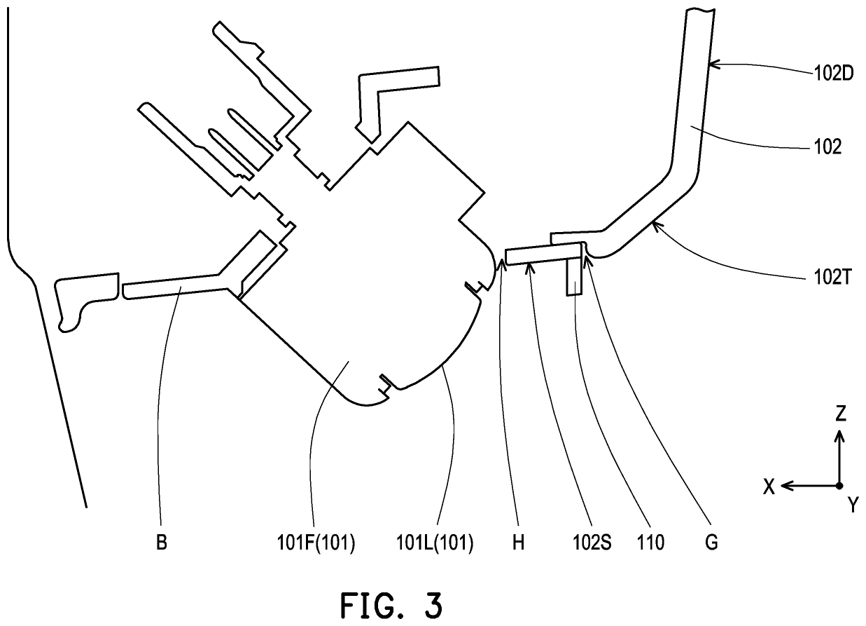

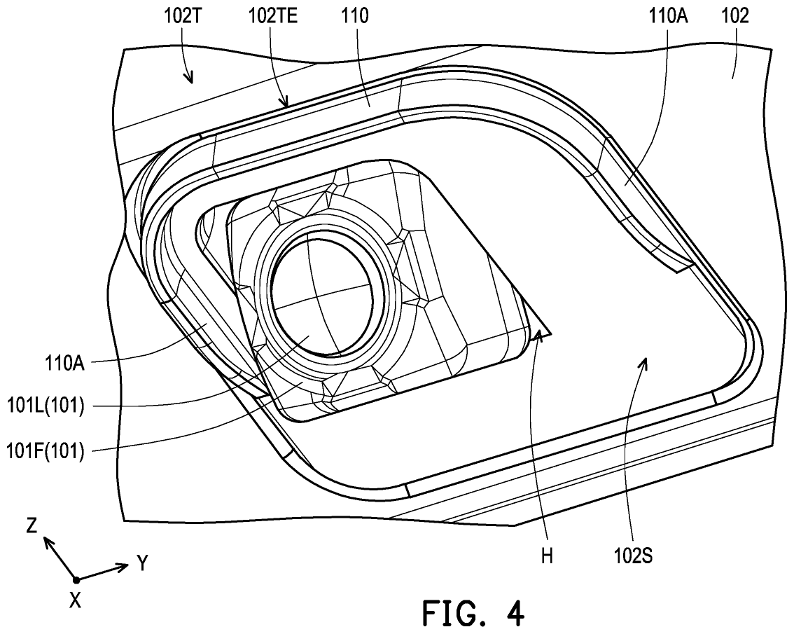

FIG. 1 is a schematic view of a vehicle having a vehicle body rear structure according to an embodiment of the disclosure. FIG. 2 is a schematic view of the vehicle body rear structure according to an embodiment of the disclosure. FIG. 3 is a schematic cross-sectional view taken along a line AA in FIG. 2. FIG. 4 is a schematic view of the vehicle body rear structure of FIG. 2 viewed from a different viewing angle.

In this embodiment, vehicle body rear structure is, for example, a part of a vehicle back door of a vehicle, and a camera device is mounted on the rear of the vehicle for detecting the presence or absence of an object behind the vehicle and the distance or relative position between the object and the vehicle. The vehicle back door includes, for example, a license plate mounting portion provided on the vehicle back door of the vehicle on which a license plate is mounted, a camera device, a garnish piece disposed above the camera device, and the like.

With reference to FIG. 1 and FIG. 2, in this embodiment, a vehicle body rear structure 100 includes a camera device 101, an exterior member 102, and a protruding strip portion 110. In this embodiment, the camera device 101 is disposed at the rear of a vehicle, and the camera device 101 is detachably mounted on the exterior member 102, for example.

In this embodiment, the camera device 101 of the vehicle body rear structure 100 is disposed at the rear of the vehicle to capture the scene behind the vehicle. The camera device 101 includes a lens 101L, a frame 101F that accommodates the lens 101L, a base plate, and the like. The camera device 101 is configured to transmit a captured image as an electric signal to a display device such as a monitor inside the vehicle. By showing the captured image on the display device, the driver can confirm the situation behind the vehicle.

The exterior member 102 is, for example, a part of the vehicle back door and is a backdoor garnish for mounting the surveillance camera device 101, a license plate light, and the like, for example. The exterior member 102 is, for example, disposed on the vehicle back door and allows the license plate mounting portion on which the license plate is mounted to be hidden, and improved appearance is thereby provided. The exterior member 102 has a mounting surface 102S on which the camera device 101 is mounted and a tilted surface 102T tilted from the mounting surface toward a rear upper part of the vehicle.

As shown in FIG. 2 and FIG. 3, the exterior member 102 is formed with an opening H for mounting the camera device 101, and the camera device 101 is detachably mounted on the exterior member 102 via the opening H. The protruding strip portion 110 is disposed at a position further rearward of the vehicle than the camera device 101 and further forward of the vehicle than the tilted surface 102T. As shown in FIG. 2, when viewed from the rear of the vehicle, the protruding strip portion 110 is located above the camera device 101 and is formed on the mounting surface 102S so as to cover the camera device 101 below. As shown in FIG. 3, when viewed from the side of the vehicle, the protruding strip portion 110 protrudes further toward the rear of the vehicle than the camera device 101, and when compared to the tilted surface 102T, the protruding strip portion 110 is disposed at a position further toward the front of the vehicle than the tilted surface 102T. That is, when viewed from the side of the vehicle, the tilted surface 102T faces further toward the rear of the vehicle than the protruding strip portion 110, and the camera device 101 is entirely covered by the tilted surface 102T from the above and is well protected.

According to the vehicle body rear structure 100 provided by this embodiment, the protruding strip portion 110 is disposed at a position further rearward of the vehicle than the camera device 101 and further forward of the vehicle than the tilted surface 102T of the exterior member 102. Therefore, the water droplets at the rear of the vehicle roll downward along the tilted surface 102T, and the water droplets rolling along the tilted surface 102T can pass through the protruding strip portion 110 and then are certain to fall down without adhering to the camera device 101.

In this embodiment, the design of each member of the vehicle body rear structure 100 is made for the purpose of enabling water droplets to roll and drip. Whether the water droplets rolling along the surface of the exterior member 102 will continue to roll is closely related to the relationship between the surface tension of the water droplets and the mass of the water droplets, and the surface tension of the water droplets in turn depends on the contact area (adhesion area) between the water droplets and the surface to which the water droplets is adhered. When the contact area of the water droplets is large, the surface tension of the water droplets will also be large, making it difficult for the water droplets to roll. When the mass of the water droplets is not large enough, it will make it difficult for the water droplets to roll, so the water droplets will adhere to the surface. Therefore, the conditions required for a water droplet to roll on the surface of an object are related to the mass of the water droplet and the adhesion area of the water droplet. In this embodiment, by designing the structure of the parts (e.g., the exterior member 102 on which the camera device 101 is mounted) through which the water droplets pass, the mass of the water droplets is increased and the contact area of the water droplets is decreased, so that the water droplets are certain to roll and finally fall down.

In this embodiment, the vehicle body rear structure 100 is designed for the flowing mechanism of water droplets on the outer surface of the exterior member 102 at the rear of the vehicle. In this way, the water droplets on the outer surface of the exterior member 102 may be prevented from adhering to the camera device 101 and are certain to roll and finally fall down.

To be specific, as shown in FIG. 2 to FIG. 4, the opening H for mounting the camera device 101 is formed on the mounting surface 102S of the exterior member 102, and the camera device 101 is mounted on the opening H of the mounting surface 102S at a tilting angle that meets the requirement of the capturing range of the image to be captured. The mounting surface 102S is positioned below the tilted surface 102T and is provided in a continuous manner from the lower end edge of the tilted surface 102T. The mounting surface 102S is configured to be, for example, a flat surface on which the opening H for mounting of the camera device 101 is formed.

The protruding strip portion 110 protrudes from the mounting surface 102S and is disposed at a position further rearward of the vehicle than the camera device 101 and further forward of the vehicle than the tilted surface 102T. When viewed from the side of the vehicle, the protruding strip portion 110 is positioned further above the upper end edge of the camera device 101, and the protruding strip portion 110 is like forming an eaves or a canopy of the camera device 101. Further, the protruding strip portion 110 protrudes from the surface of the mounting surface 102S, and the protruding front end of the protruding strip portion 110 is positioned further toward the rear of the vehicle than the camera device 101, that is, further toward the outside of the vehicle than the camera device 101. Compared with the tilted surface 102T, the protruding front end of the protruding strip portion 110 is positioned further toward the front of the vehicle than a lowermost lower end edge 102TE of the tilted surface 102T. That is, the portion (lower end edge 102TE) of the end edge of the tilted surface 102T that is connected to the mounting surface 102S further protrudes toward the outside of the vehicle than the front end of the protruding strip portion 110. In this way, the water droplets at the rear of the vehicle roll downward along the tilted surface 102T and reach the protruding strip portion 110 when rolling to the lower end edge 102TE of the tilted surface 102T. Therefore, the water droplets do not roll to the place where the camera device 101 is located. After reaching the protruding strip portion 110, the water droplets dropping along the tilted surface 102T can pass through the protruding strip portion 110 and are certain to fall down, such that the water droplets are certain to be prevented from adhering to the camera device 101.

In this embodiment, the exterior member 102 includes an appearance surface 102D from which an appearance design may be observed from the rear of the vehicle, and the tilted surface 102T is tilted further forward of the vehicle than the appearance surface 102D. As shown in FIG. 3, the exterior member 102 is formed by the upper appearance surface 102D, the tilted surface 102T formed continuously with the appearance surface 102D, and the mounting surface 102S formed continuously with the tilted surface 102T facing downward of the vehicle. As shown in FIG. 3, the tilting angles of the appearance surface 102D, the tilted surface 102T, and the mounting surface 102S of the exterior member 102 in the vertical direction of the vehicle are different from one another, so the sense of design of the exterior member 102 is improved.

In this way, in the structure of the exterior member 102 provided by this embodiment, the appearance surface 102D is connected to the tilted surface 102T, and the tilted surface 102T is arranged to be tilted further forward of the vehicle from the appearance surface 102D. Therefore, when viewed from the rear of the vehicle, the degrees of tilting of the appearance surface 102D and the tilted surface 102T change, so designability of the exterior member 102 is enhanced, and the aesthetic feeling and the sense of design are thereby improved. Besides, when the outer side of the exterior member 102 which is a part of the vehicle back door is viewed from the rear of the vehicle, the appearance surface 102D of the appearance design of the exterior member 102 can be seen.

In this embodiment, in addition to the arrangement of the protruding strip portion 110, the vehicle body rear structure 100 further includes a side protruding portion 110A. As shown in FIG. 2 and FIG. 4, the side protruding portion 110A is continuously arranged with the protruding strip portion 110 and is located on a side of the camera device 101. The side protruding portion 110A covers at least a portion of the camera device 101. According to the structure of the side protruding portion 110A provided by this embodiment, the water droplets passing through the side protruding portion 110A along the side of the camera device 101 are certain to fall down.

In this embodiment, as shown in FIG. 2 and FIG. 4, the protruding strip portion 110 has a protruding structure such as a rib to protrude from the mounting surface 102S and is arranged above the upper end edge of the frame 101F of the camera device 101 so as to extend in a vehicle width direction Y. In this way, the water droplets rolling down from the tilted surface 102T are certain to fall down via the protruding strip portion 110 without adhering to the camera device 101. In this embodiment, the side protruding portion 110A is arranged, the side protruding portion 110A is continuously arranged with the protruding strip portion 110 and located on the side of the camera device 101. Further, the side protruding portion 110A covers at least a portion of the camera device 101 on the rear side of the vehicle.

In this embodiment, as shown in FIG. 4, the side protruding portion 110A is arranged so as to extend continuously downward from both ends of the protruding strip portion 110. The position where the side protruding portion 110A extends may be any position that can receive the water droplets directed toward the camera device 101 from the side, so that the water droplets can pass through the side protruding portion 110A and are certain to roll and fall down. Therefore, the side protruding portion 110A is not required to be configured to exceed the length of the side of the camera device 101. The protruding strip portion 110 and the side protruding portion 110A are formed in a U-shaped protruding structure protruding from the surface of the mounting surface 102S. In this way, the water droplets from the side of the camera device 101 are certain to fall down via the side protruding portion 110A.

In addition, in this embodiment, as shown in FIG. 4, compared to the lens 101L of the camera device 101, the side protruding portion 110A is arranged to face further forward of the vehicle than the lens 101L to be continuous with the protruding strip portion 110. The side protruding portion 110A can at least block the water droplets sprayed toward the lens 101L of the camera device 101, and the water droplets directed toward the lens 101L from the side of the camera device 101 are certain to fall down via the side protruding portion 110A.

In this embodiment, as shown in FIG. 3, in addition to allowing the camera device 101 to be directly mounted on the opening H formed in the mounting surface 102S of the exterior member 102, a bracket B may also be arranged. The camera device 101 may be mounted on the exterior member 102 via the bracket B. Herein, the protruding strip portion 110 may be directly disposed on the bracket B. According to the arrangement of the bracket B, the protruding strip portion 110 may be easily and conveniently mounted on the bracket B.

As shown in FIG. 3, the protruding strip portion 110 may be disposed on the bracket B, such that the protruding strip portion 110 may be easily disposed on the bracket B. In addition, the side protruding portion 110A may also be easily disposed on the bracket B. For instance, the bracket B may be arranged in such a manner that the side protruding portion 110A and the protruding strip portion 110 are integrally formed, and assembly may thus be easily performed.

In addition, as shown in FIG. 3, the protruding strip portion 110 is at least formed at a vehicle rear side end portion of the bracket B, and a groove-shaped gap G is formed between the vehicle rear side end portion of the bracket B and the exterior member 102. According to the design structure of the groove-shaped gap G, water droplets may enter the gap G formed between the bracket B and the exterior member 102. After the water droplets are accumulated, larger water droplets are formed, and the water droplets pass through the protruding strip portion 110 and then are certain to fall down.

In this way, in this embodiment, due to the arrangement of the bracket B, the groove-shaped gap G is formed at the joint between the bracket B and the exterior member 102. The water droplets from the upper tilted surface 102T enter the gap G, and after the water droplets are accumulated in the gap G, the mass of the water droplets increases. Further, since the gap is small, the contact area of the water droplets is reduced. The water droplets may continue to roll to the lower protruding strip portion 110, and the water droplets passing through the protruding strip portion 110 are then certain to fall down, so that the water droplets are prevented from adhering to the camera device 101.

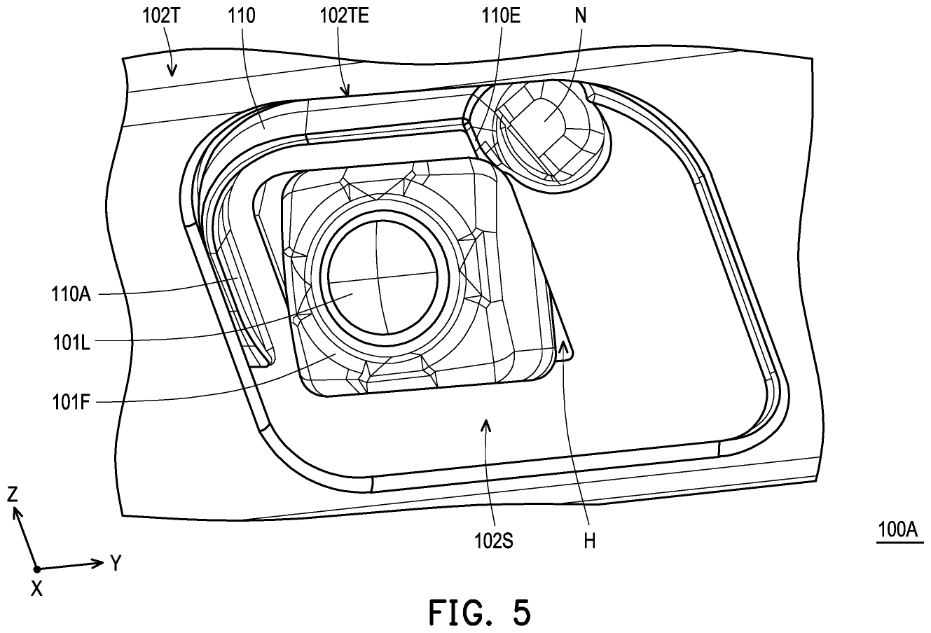

FIG. 5 is a schematic view of a vehicle body rear structure according to another embodiment of the disclosure. As shown in FIG. 5, in a vehicle body rear structure 100A provided by this embodiment, the lens of the camera device 101 may get dirty. In order to remove dirt on the lens 101L of the camera device 101, a nozzle N capable of ejecting liquid (e.g., water, cleaning liquid, etc.) to the camera device 101 may be provided to clean the camera device 101 and/or the lens 101L of the camera device 101. As shown in FIG. 5, in this embodiment, the nozzle N is disposed at a position further rearward of the vehicle than the camera device 101 and is configured for ejecting liquid toward the camera device 101 and/or the lens 101L of the camera device 101. The nozzle N and the camera device 101 are arranged not to overlap in the vehicle width direction Y. The nozzle N and the protruding strip portion 110 are arranged side by side in the vehicle width direction Y. The protruding strip portion 110 is arranged to be closer to the camera device 101 side than the nozzle N.

In this embodiment, as shown in FIG. 5, the nozzle N is disposed at a position further rearward of the vehicle than the camera device 101. That is, when viewed from the side of the vehicle, the nozzle N protrudes further toward the rear of the vehicle than the camera device 101, and the nozzle N and the camera device 101 are arranged not to overlap in the vehicle width direction Y. Further, the nozzle N and the protruding strip portion 110 are arranged side by side in the vehicle width direction Y. For instance, in the vehicle width direction Y, the nozzle N and the extending direction of the protruding strip portion 110 are substantially on the same straight line, and the nozzle N is arranged in such a manner that the position of the protruding strip portion 110 is closer to the camera device 101 side than the nozzle N.

In this way, as shown in FIG. 5, above the camera device 101, since the nozzle N is provided side by side with the protruding strip portion at one end of the protruding strip portion 110, the nozzle N may function as the protruding strip portion 110 to serve as an eaves or a canopy of the camera device 101. In this way, the water droplets rolling down from the tilted surface 102T pass through the nozzle N and then are certain to fall down, so that the droplets are prevented from adhering to the camera device 101.

In this embodiment, as shown in FIG. 5, by utilizing the limited space of the mounting surface 102S and arranging the nozzle N to be disposed side by side with the protruding strip portion 110, the nozzle N can not only be used to clean the camera device 101 and/or the lens 101L of the camera device 101 but also serve to prevent water droplets from adhering to the lens 101L when not performing cleaning.

In addition, in this embodiment, as shown in FIG. 5, when the protruding strip portion 110 and the nozzle N are arranged side by side, between the protruding strip portion 110 and the nozzle N, an extension portion 110E may be provided. To be specific, as shown in FIG. 5, the extension portion 110E is located between the protruding strip portion 110 and the nozzle N and extends from the end of the protruding strip portion 110 adjacent to the nozzle N toward the camera device 101. In this way, by providing the extension portion 110E between the protruding strip portion 110 and the nozzle N, water droplets are prevented from detouring from the side surface of the protruding strip portion 110 and adhering to the camera device 101.

In this embodiment, the partition-like extension portion 110E is provided between the protruding strip portion 110 and the nozzle N, and in this way, the water droplets detouring around the side surface (i.e., the end portion of the protruding strip portion 110 close to the nozzle N) of the protruding strip portion 110 due to the surface tension can be prevented from sliding down toward the camera device 101 and adhering to the lens 101L. In other words, the extension portion 110E is like a wall formed among the camera device 101, the protruding strip portion 110 and the nozzle N.

In addition, in this embodiment, as shown in FIG. 5, the extension portion 110E is arranged not to overlap an ejection range of the liquid from the nozzle N, so that the nozzle N can surely clean the camera device 101 and/or the lens 101L of the camera device 101. In this way, the detouring of water droplets may be prevented from occurring by the extension portion 110E. Further, by arranging the extension portion 110E not to overlap the ejection range of the liquid from the nozzle N, cleaning of the lens 101L of the camera device 101 is not hindered. In other words, in this embodiment, the extension portion 110E is arranged in such a manner that the height of the extension portion 110E protruding from the mounting surface 102S does not interfere with the ejection range of the cleaning liquid ejected from the nozzle N.

In addition, similar to the arrangement of the side protruding portion 110A shown in the embodiment of FIG. 4, in the embodiment of FIG. 5, the side protruding portion 110A is continuously arranged with the protruding strip portion 110 and is located on a side of the camera device 101 opposite to the nozzle Z side. The side protruding portion 110A covers at least a portion of the camera device 101. In this way, the water droplets passing through the side protruding portion 110A along the side of the camera device 101 are certain to fall.

Besides, as shown in FIG. 5, the bracket B may also be provided similarly. The camera device 101 is mounted on the exterior member 102 via the bracket B, and the nozzle N is disposed on the bracket B. In this way, through arrangement of the bracket B, the nozzle N may be easily and conveniently mounted on the bracket B. To be specific, in this embodiment, as shown in FIG. 5, the mounting surface 102S may be directly formed on the exterior member 102, or the bracket B may be used, and the bracket B may be disposed on the exterior member 102 and the bracket B may be used as the mounting surface. The camera device 101 is mounted on the exterior member via the bracket B. With such a design, the nozzle N may be disposed on the bracket B, the nozzle N may be easily mounted on the bracket B, and assembly may thus be easily performed.

In addition, in this embodiment, just as the nozzle N can be easily disposed on the bracket B, the protruding strip portion 110 may also be disposed on the bracket B, and the side protruding portion 110A and the extension portion 110E may also be disposed on the bracket B. In this way, the protruding strip portion 110, the side protruding portion 110A, and the extension portion 110E may be easily disposed on the bracket B. For instance, the bracket B may be arranged in such a manner that the side protruding portion 110A, the protruding strip portion 110, and the extension portion 110E are integrally formed, and assembly may thus be easily performed.

In view of the foregoing, in the vehicle body rear structure provided by the disclosure, the protruding strip portion is disposed at a position further rearward of the vehicle than the camera device and further forward of the vehicle than the tilted surface of the exterior member. In this way, the water droplets at the rear of the vehicle roll downward along the tilted surface and reach the protruding strip portion when rolling to the lower end edge of the tilted surface. Therefore, the water droplets do not roll to the place where the camera device is located. After reaching the protruding strip portion, the water droplets dropping along the tilted surface can pass through the protruding strip portion and are certain to fall down, such that the water droplets are surely prevented from adhering to the camera device. Besides, as the camera device includes a nozzle for cleaning the camera device, by arranging the nozzle to be disposed side by side with the protruding strip portion, water droplets can pass through the protruding strip portion and the nozzle and then are certain to fall down, such that the water droplets are prevented from adhering to the camera device.

Finally, it is worth noting that the foregoing embodiments are merely described to illustrate the technical solutions of the disclosure and should not be construed as limitations of the disclosure. Even though the foregoing embodiments are referenced to provide detailed description of the disclosure, a person having ordinary skill in the art should understand that various modifications and variations can be made to the technical solutions in the disclosed embodiments, or equivalent replacements may be made for part or all of the technical features. Nevertheless, it is intended that the modifications, variations, and replacements shall not make the nature of the technical solutions depart from the scope of the technical solutions of the embodiments of the disclosure.

What is claimed is:

1. A vehicle body rear structure, comprising:
a camera device, disposed at the rear of a vehicle;
an exterior member, having a mounting surface on which the camera device is mounted and a tilted surface tilted from the mounting surface toward a rear upper part of the vehicle; and
a protruding strip portion, disposed at a position further rearward of the vehicle than the camera device and further forward of the vehicle than the tilted surface.

2. The vehicle body rear structure according to claim 1, wherein
the exterior member comprises an appearance surface from which an appearance design is observed from the rear of the vehicle, and
the tilted surface is tilted further forward of the vehicle than the appearance surface.

3. The vehicle body rear structure according to claim 1, further comprising:
a side protruding portion, continuously arranged with the protruding strip portion and located on a side of the camera device, wherein the side protruding portion covers at least a portion of the camera device.

4. The vehicle body rear structure according to claim 3, wherein
the camera device comprises a lens, and the side protruding portion is arranged to face further forward of the vehicle than the lens to be continuous with the protruding strip portion.

5. The vehicle body rear structure according to claim 1, further comprising:
a nozzle, disposed at a position further rearward of the vehicle than the camera device and configured for ejecting liquid toward the camera device, wherein the nozzle and the camera device are arranged not to overlap in a vehicle width direction,
the nozzle and the protruding strip portion are arranged side by side in the vehicle width direction, and
the protruding strip portion is arranged to be closer to the camera device side than the nozzle.

6. The vehicle body rear structure according to claim 5, further comprising:
an extension portion, located between the protruding strip portion and the nozzle and extending from an end of the protruding strip portion adjacent to the nozzle toward the camera device.

7. The vehicle body rear structure according to claim 6, wherein
the extension portion is arranged not to overlap an ejection range of the liquid from the nozzle.

8. The vehicle body rear structure according to claim 5, further comprising:
a side protruding portion, continuously arranged with the protruding strip portion and located on a side of the camera device opposite to the nozzle, wherein the side protruding portion covers at least a portion of the camera device.

9. The vehicle body rear structure according to claim 5, further comprising:
a bracket, wherein the camera device is mounted on the exterior member via the bracket, and the nozzle is disposed on the bracket.

10. The vehicle body rear structure according to claim 1, further comprising:
a bracket, wherein the camera device is mounted on the exterior member via the bracket, and the protruding strip portion is disposed on the bracket.

11. The vehicle body rear structure according to claim 10, wherein
the protruding strip portion is at least formed at a vehicle rear side end portion of the bracket, and
a groove-shaped gap is formed between the vehicle rear side end portion of the bracket and the exterior member.
